(19) United States
(12) Patent Application Publication
(10) Pub. No.: US 2012/0088117 A1
(43) Pub. Date: Apr. 12, 2012

(54) SUBSTRATE STRUCTURE

(75) Inventor: Chih-Hong Chuang, Hsinchu (TW)

(73) Assignee: Subtron Technology Co., Ltd., Hsinchu (TW)

(21) Appl. No.: 12/955,887

(22) Filed: Nov. 29, 2010

(30) Foreign Application Priority Data
Oct. 11, 2010 (TW) 99134597

(51) Int. Cl. B32B 15/20; B32B 15/00; B32B 3/10

(52) U.S. Cl. 428/596

(57) ABSTRACT

A substrate structure including a first metal substrate, a second metal substrate, a frame fixture, a first conductive layer, a second conductive layer, a first adhesive layer and a second adhesive layer is provided. The second metal substrate is stacked over the first metal substrate. The frame fixture is disposed around the first metal substrate and the second metal substrate. The first adhesive layer is disposed between the first conductive layer and the first metal substrate, and between the first conductive layer and the frame fixture. The first conductive layer is fixed on an upper surface of the frame fixture by the first adhesive layer. The second adhesive layer is disposed between the second conductive layer and the second metal substrate, and between the second conductive layer and the frame fixture. The second conductive layer is fixed on a lower surface of the frame fixture by the second adhesive layer.

### CROSS-REFERENCE TO RELATED APPLICATION

This application claims the priority benefit of Taiwan application serial no. 99134597, filed on Oct. 11, 2010. The entirety of the above-mentioned patent application is hereby incorporated by reference herein and made a part of this specification.

### BACKGROUND OF THE INVENTION

1. Field of the Invention

The invention relates to a substrate structure, and more particularly, to a substrate structure with better reliability.

2. Description of Related Art

Following the rapid development of the digital industry, the circuit board application on digital products is becoming more and more widespread, such as mobile phones, computers, digital cameras and other products that have circuit boards. In manufacturing circuit boards, circuit boards can be obtained by a single side circuit substrate or a double side circuit substrate.

In the conventional process of manufacturing a single side circuit substrate, two copper foil layers and a core layer disposed in the copper foil layers are provided. The copper foil layers and the core layer are compressed. Then, a side of the copper foil layer is removed through etching, to obtain a single side substrate. However, the conventional manufacturing method wastes a side of the copper foil layer, and requires another etching process to remove the copper foil layer, increasing the manufacturing process steps and manufacturing cost. In addition, if when the core layer is made of a metal with a fast reaction rate to the etching solution, then an additional protective layer must first be formed to protect the core layer. Then, the etching process can remove the copper foil layer, or else the etching solution will cause the core layer to erode, lowering the reliability of the substrate. Since an additional protective layer is needed to protect the core layer, the manufacturing steps and the manufacturing cost is increased, making production disadvantageous.

### SUMMARY OF THE INVENTION

The invention provides a substrate structure comprising a frame fixture that can surround the metal substrate, to prevent erosion in the metal substrate from the etching solution in the follow up manufacturing processes, thus improving the reliability of the substrate.

The invention provides a substrate structure comprising a first metal substrate, a second metal substrate, a frame fixture, a first conductive layer, a second conductive layer, a first adhesive layer, and a second adhesive layer. The first metal substrate has a first surface. The second metal substrate is stacked over the first metal substrate, and includes a second surface. The frame fixture is disposed around the first metal substrate and the second metal substrate, and includes an upper surface and a lower surface relatively opposite to each other. The first conductive layer is disposed on the upper surface of the frame fixture, and covers the first surface of the first metal substrate. The second conductive layer is disposed on the lower surface of the frame fixture, and covers the second surface of the second metal substrate. The first adhesive layer is disposed between the first conductive layer and the first metal substrate, and between the first conductive layer and the frame fixture. The first conductive layer is fixed on the upper surface of the frame fixture by the first adhesive layer. The second adhesive layer is disposed between the second conductive layer and the second metal substrate, and between the second conductive layer and the frame fixture. The second conductive layer is fixed on the lower surface of the frame fixture by the second adhesive layer.

According to an embodiment of the invention, the first surface of the first metal substrate is substantially aligned with the upper surface of the frame fixture.

According to an embodiment of the invention, the second surface of the second metal substrate is substantially aligned with the lower surface of the frame fixture.

In an embodiment of the invention, the sides of the first metal substrate and the second metal substrate lean against the frame fixture.

According to an embodiment of the invention, the frame fixture surrounds to form a rectangle.

According to an embodiment of the invention, a material of the first metal substrate includes aluminum.

According to an embodiment of the invention, a material of the second metal substrate includes aluminum.

According to an embodiment of the invention, a material of the frame fixture comprises plastic, glass fiber, cast iron, or metal.

According to an embodiment of the invention, a material of the first conductive layer comprises copper foil.

According to an embodiment of the invention, a material of the second conductive layer comprises copper foil.

Based on the above, since the frame fixture of the embodiment is disposed around the first metal substrate and the second metal substrate, during the wet etching process for subsequent formation of the circuits, erosion in the first metal substrate and the second metal substrate from the etching solution is prevented, thus improving the reliability of the substrate structure. In addition, since the frame fixture of the invention can protect the first metal substrate and the second metal substrate, an additional protecting layer is not required, thus reducing the manufacturing steps of the subsequent circuits and also reducing the manufacturing cost.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional exploded schematic view of a substrate structure according to an embodiment of the invention.

FIG. 2 is a schematic cross-sectional view of a substrate structure according to an embodiment of the invention.

### DESCRIPTION OF EMBODIMENTS

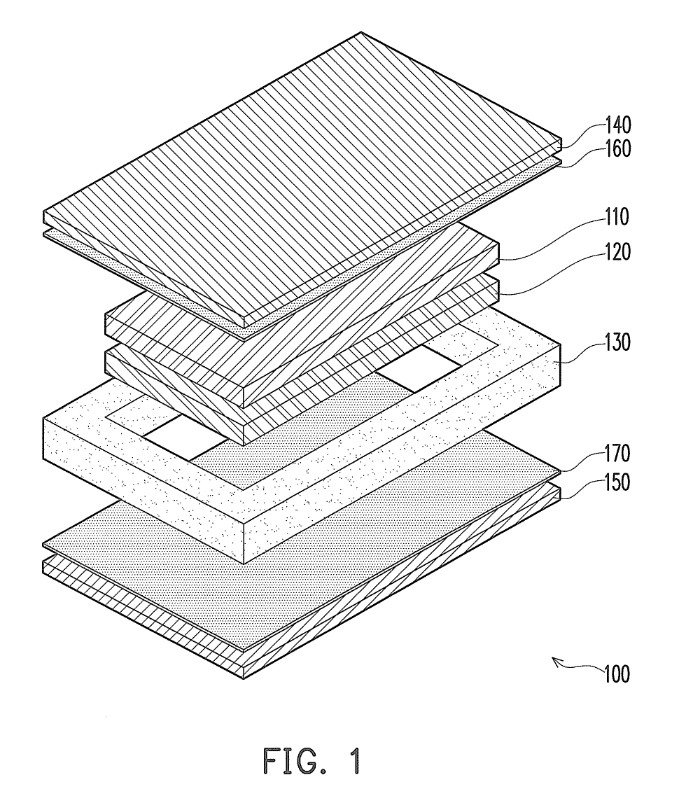

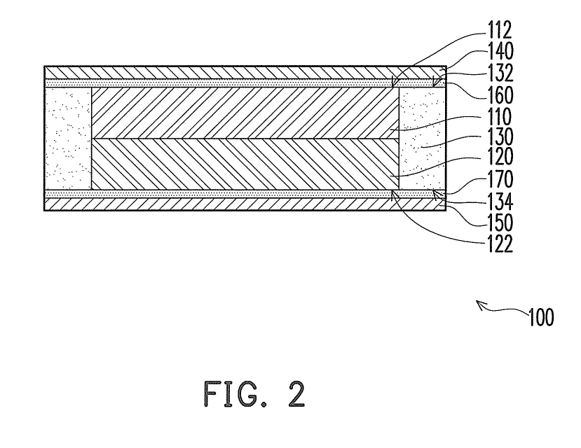

FIG. 1 is a three-dimensional exploded schematic view of a substrate structure according to an embodiment of the invention. FIG. 2 is a schematic cross-sectional view of a substrate structure according to an embodiment of the invention. Referring to FIG. 1 and FIG. 2, in the embodiment, a substrate structure 100 comprises a first metal substrate 110, a second metal substrate 120, a frame fixture 130, a first conductive layer 140, a second conductive layer 150, a first adhesive layer 160, and a second adhesive layer 170.

In detail, the first metal substrate 110 has a first surface 112. The second metal substrate 120 is stacked over the first metal substrate 110, and includes a second surface 122. In the embodiment, the first metal substrate 110 and the second metal substrate 120 have substantially identical parameters, and a material of the first metal substrate 110 is for example, aluminum. A material of the second metal substrate 120 can be the same as the material of the first metal substrate 110, namely, the material of the second metal substrate 120 is for example, aluminum, but is not limited thereto. Since the material of the first metal substrate 110 and the second metal substrate 120 is aluminum, which has better thermal conductivity, in the application of subsequent products, the metal substrates are suitable to be a heat dissipating substrate, which can rapidly conduct the heat generated by a heat emitting device (not shown). Thereby, the working temperature of the heat emitting device is decreased.

The frame fixture 130 is disposed around the first metal substrate 110 and the second metal substrate 120, and includes an upper surface 132 and a lower surface 134 relatively opposite to each other. In detail, according to the embodiment, the first surface 112 of the first metal substrate 110 is substantially aligned with the upper surface 132 of the frame fixture 130, but is not limited thereto. The second surface 122 of the second metal substrate 120 is substantially aligned to the lower surface 134 of the frame fixture 130, but is not limited thereto. The sides of the first metal substrate 110 and the second metal substrate 120 lean against the frame fixture 130, and the frame fixture 130 surrounds to form for example, a rectangle, but the invention is not limited to this structure. Moreover, a material of the frame fixture 130 of the embodiment is for example, plastic or metal. For example, if the material of the frame fixture 130 is plastic, the frame fixture 130 can be formed using an injection molding method, which has the advantage of a low production cost. If the material of the frame fixture 130 is metal, the etching response rate must be slower than the etching response rate of the first metal substrate 110 and the second metal substrate 120. This facilitates the steps for the manufacturing process of subsequent circuits, wherein the metal is for example, copper.

The first conductive layer 140 is disposed on the upper surface 132 of the frame fixture 130, and covers the first surface 112 of the first metal substrate 110. The second conductive layer 150 is disposed on the lower surface 134 of the frame fixture 130, and covers the second surface 122 of the second metal substrate 120. In the embodiment, a material of the first conductive layer 140 is for example, copper foil, and a material of the second conductive layer 150 is the same as the material for the first conductive layer 140. Namely, the material for the second conductive layer 150 is for example, copper foil, but is not limited thereto.

The first adhesive layer 160 is disposed between the first conductive layer 140 and the first metal substrate 110, and between the first conductive layer 140 and the frame fixture 130. The first conductive layer 140 is fixed on the upper surface 132 of the frame fixture 130 and the first surface 112 of the first metal substrate 110 by the first adhesive layer 160. The second adhesive layer 170 is disposed between the second conductive layer 150 and the second metal substrate 120, and between the second conductive layer 150 and the frame fixture 130. The second conductive layer 150 is fixed on the lower surface 134 of the frame fixture 130 and the second surface 122 of the second metal substrate 120 by the second adhesive layer 170. In addition, the first adhesive layer 160 and the second adhesive layer 170 of the embodiment is for example, cyanoacrylate (usually referred to as instant glue) or polypropylene resin (known as PP glue).

Since the frame fixture 130 of the embodiment is disposed around the first metal substrate 110 and the second metal substrate 120, during the wet etching process for subsequent formation of the circuits, erosion in the first metal substrate 110 and the second metal substrate 120 from the etching solution is prevented, thus improving the reliability of the substrate structure 100. In addition, since the frame fixture 130 of the embodiment can protect the first metal substrate 110 and the second metal substrate 120, an additional protecting layer is not required, thus reducing the manufacturing steps of the subsequent circuits and also reducing the manufacturing cost.

The above only describes the structural design of the substrate structure 100 of the invention, while a manufacturing method of the substrate structure 100 is not yet introduced in the invention. The following serves to describe a method for manufacturing the substrate structure 100 of the aforementioned embodiment. It should be noted that the below embodiment uses the same component references and subject matter as the above embodiment, to omit the description of identical content. For a detailed description of the omitted content, please refer to the above embodiment, the below embodiment will not repeat unnecessary details.

Please refer to FIG. 1 and FIG. 2. According to the manufacturing method of a substrate structure 100 in the embodiment, a first metal substrate 110, a second metal substrate 120, a frame fixture 130, a first conductive layer 140, a second conductive layer 150, a first adhesive layer 160, and a second adhesive layer 170 are provided.

Next, the first metal substrate 110 and the second metal substrate 120 are placed in the frame fixture 130, so that the frame fixture 130 is disposed around the first metal substrate 110 and the second metal substrate 120. The frame fixture 130 surrounds to form for example, a rectangle, but the invention is not limited to this structure. In detail, the first metal substrate 110 and the second metal substrate 120 are stacked. A first surface 112 of the first metal substrate 110 is substantially aligned with an upper surface 132 of the frame fixture 130. A second surface 122 of the second metal substrate 120 is substantially aligned with the lower surface 134 of the frame fixture 130. The sides of the first metal substrate 110 and the second metal substrate 120 lean against the frame fixture 130.

Next, a compression process is performed so that the first adhesive layer 160 and the first conductive layer 140 are sequentially stacked onto the first surface 112 of the first metal substrate 110 and the upper surface 132 of the frame fixture 130. Also, the second adhesive layer 170 and the second conductive layer 150 are sequentially stacked onto the second surface 122 of the second metal substrate 120 and the lower surface 134 of the frame fixture 130. The first conductive layer 140 is fixed on the frame fixture 130 and the first metal substrate 110 by the first adhesive layer 160. The second conductive layer 150 is fixed on the frame fixture 130 and the second metal substrate 120 by the second adhesive layer 170. Up to this stage, the fabrication of the substrate structure 100 is mostly completed.

It should be noted that during the manufacturing process, the first adhesive layer 160 and the second adhesive layer 170 can respectively be, for example, a semi-cured adhesive layer. When the first adhesive layer 160 and the second adhesive layer 170 is exposed to heat, part of the melted first adhesive layer 160 and the second adhesive layer 170 will flow between the first metal substrate 110 and the frame fixture 130, and between the second metal substrate 120 and the frame fixture 130. Therefore, there is an improvement of a bonding force between the first metal substrate 110 and the frame fixture 130, and between the second metal substrate 120 and the frame fixture 130.

In addition, in the follow up manufacturing processes, the user can directly manufacture a circuit on the substrate structure 100, which means the first conductive layer 140 and the second conductive layer 150 respectively forms at least one circuit layer (not shown) and a solder mask layer (not shown). During the wet etching process of the circuit manufacture, since the frame fixture 130 of the embodiment is disposed around the first metal substrate 110 and the second metal substrate 120, the frame fixture 130 can serve as a protective layer. Therefore, the etching solution is effectively stopped from eroding the first metal substrate 110 and the second metal substrate 120, and there is no need for an additional protective layer, reducing the circuit manufacturing steps and the production cost.

In addition, after completing the subsequent circuit manufacturing process, a Computer Numerical Control (CNC) technique can cut the frame fixture 130, so the substrate structure 100 and the circuits form two independent single side circuit board substrates (not shown). Each single side circuit board substrate comprises the first metal substrate 110 (or the second metal substrate 120), the first adhesive layer 160 (or the second adhesive layer 170), the first conductive layer 140 (or the second conductive layer 150), and the circuit formed on the first conductive layer 140 (or the second conductive layer 150). Therefore, time and cost of manufacturing a single side circuit substrate is saved so that the throughput is increased.

In summary, since the frame fixture of the embodiment is disposed around the first metal substrate and the second metal substrate, during the wet etching process for subsequent formation of the circuits, the frame fixture can serve as a protective layer, so erosion in the first metal substrate and the second metal substrate from the etching solution is prevented, thus improving the reliability of the substrate structure. In addition, since the frame fixture of the invention can protect the first metal substrate and the second metal substrate, an additional protecting layer is not required, thus reducing the manufacturing steps of the subsequent circuits and also reducing the manufacturing cost. Also, after completing the subsequent circuit manufacturing process, by cutting the frame fixture, the single substrate structure and the circuit formed thereon form two independent single side circuit board substrates (comprising the metal substrate, the adhesive layer, the conductive layer, and the circuit formed on the conductive layer). Therefore, time and cost of manufacturing a single side circuit substrate is saved so that the throughput is increased.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A substrate structure, comprising:
a first metal substrate having a first surface;
a second metal substrate, stacked over the first metal substrate and having a second surface;
a frame fixture, disposed around the first metal substrate and the second metal substrate, and having an upper surface and a lower surface relatively opposite to each other;
a first conductive layer, disposed on the upper surface of the frame fixture, and covering the first surface of the first metal substrate;
a second conductive layer, disposed on the lower surface of the frame fixture, and covering the second surface of the second metal substrate;
a first adhesive layer, disposed between the first conductive layer and the first metal substrate, and between the first conductive layer and the frame fixture, wherein the first conductive layer is fixed on the upper surface of the frame fixture by the first adhesive layer; and
a second adhesive layer, disposed between the second conductive layer and the second metal substrate, and between the second conductive layer and the frame fixture, wherein the second conductive layer is fixed on the lower surface of the frame fixture by the second adhesive layer.

2. The substrate structure as claimed in claim 1, wherein the first surface of the first metal substrate is substantially aligned with the upper surface of the frame fixture.

3. The substrate structure as claimed in claim 1, wherein the second surface of the second metal substrate is substantially aligned with the lower surface of the frame fixture.

4. The substrate structure as claimed in claim 1, wherein the sides of the first metal substrate and the second metal substrate lean against the frame fixture.

5. The substrate structure as claimed in claim 1, wherein the frame fixture surrounds to form a rectangle.

6. The substrate structure as claimed in claim 1, wherein a material of the first metal substrate comprises aluminum.

7. The substrate structure as claimed in claim 1, wherein a material of the second metal substrate comprises aluminum.

8. The substrate structure as claimed in claim 1, wherein a material of the frame fixture comprises plastic, glass fiber, cast iron, or metal.

9. The substrate structure as claimed in claim 1, wherein a material of the first conductive layer comprises copper foil.

10. The substrate structure as claimed in claim 1, wherein a material of the second conductive layer comprises copper foil.
